(19) United States
(12) Patent Application Publication
(10) Pub. No.: US 2018/0229253 A1
(43) Pub. Date: Aug. 16, 2018

(54) SPRINKLER MAT

(71) Applicant: Samuel CHEN, Hung Hom (CN)

(72) Inventor: Samuel CHEN, Hung Hom (CN)

(21) Appl. No.: 15/716,946

(22) Filed: Sep. 27, 2017

Related U.S. Application Data
(60) Provisional application No. 62/458,973, filed on Feb. 14, 2017.

(51) Int. Cl. B05B 9/03; B05B 12/00; B05B 15/00; A63G 31/00

(52) U.S. Cl. CPC B05B 9/035; A63G 31/007; B05B 15/001; B05B 12/00

(57) ABSTRACT

A sprinkler mat has an intake water line connected to a water supply. The intake water line connects to a water line connection. A water controller has valves and each valve of the plurality valves is independently controlled by a CPU. The CPU has a random mode. The valves are connected to a valve manifold. A sprinkler mat is formed as a sheet and having a thickness. The sprinkler mat is connected to the water controller. Intake tubing connects each valve to a spray nozzle. The intake tubing continues internally within the sprinkler mat. Spray nozzles are connected to a respective intake tubing.

This application is a non-provisional filing of U.S. provisional application 62/458,973 entitled Sprinkler Mat by the same inventor Samuel Chen filed Feb. 14, 2017, the disclosure of which is incorporated herein by reference.

### FIELD OF THE INVENTION

The present invention is in the field of sprinkler mats.

### DISCUSSION OF RELATED ART

A variety of water spray apparatus have been made in the prior art for cooling off in the backyard during summer. For example, in Habing U.S. Pat. No. 7,606,637 issued Oct. 20, 2009, entitled Lawn Sprinkler Play Apparatus, the disclosure of which is incorporated herein by reference, discloses a sprinkler play system with a plurality of sprinkler stations that can be spaced apart on a lawn. A variety of different water conduits provide variable spray for evaporative cooling of participants. Habing references other United States patents that describe spray heads for spraying water.

Another example is Rudell et al, U.S. Pat. No. 4,982,959 issued Jan. 8, 1991, entitled Water Sprinkler Mat Game. A mat has a water distributor and a plurality of spray orifices that are located at designated positions on the surface of the game mat and connected to the water distributor whereby application of water under pressure to the water distributor forms vertical water sprays. The same inventor in U.S. Pat. No. 5,672,123, issued Sep. 30, 1997, entitled water Mat Activity with Puddles and Spray Action, discusses a mat with a wall that defines a reservoir that holds a volume of water. The wall may be inflated with water and contain apertures that continuously emit streams of water onto the mat area. In a similar invention, United States patent application publication 2006/0208101 by DeBoer et al, issued Sep. 21, 2006, entitled Lilly Pad Water Toy, there is a resilient pad connected to water supply through a flexible water conduit. The flexible water conduit is connected to the water source such that each resilient pad provides a spray or fountain of water in response to being squeezed of stepped upon. Finally, inventor Publicover et al discusses in Pool or Trampoline Game Accessory, United States patent application publication 2005/01043122, published Feb. 24, 2005, a game mat/surface over a trampoline enables the safe capture of water.

### SUMMARY OF THE INVENTION

A sprinkler mat has an intake water line connected to a water supply. The intake water line connects to a water line connection. A water controller has valves and each valve of the plurality valves is independently controlled by a CPU. The CPU has a random mode. The valves are connected to a valve manifold. A sprinkler mat is formed as a sheet and having a thickness. The sprinkler mat is connected to the water controller. Intake tubing connects each valve to a spray nozzle. The intake tubing continues internally within the sprinkler mat. Spray nozzles are connected to a respective intake tubing.

The sprinkler mat is made of a pair of sheets, wherein the conduits are configured between the pair of sheets. The the water controller uses a CPU for processing controlling different modes of operation. The water layer that is filled with water and forms a wall barrier to retain a shallow pool of open water. The a peripheral spray line has misting nozzles for emitting a fine spray, and the peripheral spray line is mounted along the periphery of the sprinkler mat.

The sprinkler mat preferably has the spray nozzles mounted to the nozzle bumpers.

### BRIEF DESCRIPTION OF THE DRAWINGS

FIG. 1 is a diagram of the present invention showing the layout of the sprinkler mat.

FIG. 2 is an illustration of the device in use.

FIG. 3 is a diagram of a misting spray spraying from a misting nozzle.

FIG. 4 is a diagram showing a high spray spraying from a high spray nozzle.

FIG. 5 is a big water droplet spray spraying from a big water spray nozzle.

FIG. 6 is a cross-section diagram of a nozzle bumper.

FIG. 7 is a diagram of a peripheral spray line.

FIG. 8 is a diagram showing the connection of the manifold cover with the intake tubing.

FIG. 9 is a diagram showing the top view of the manifold cover, the power control switch of the manifold cover, the manifold outlets on the manifold cover, and the side view of the manifold cover.

FIG. 10 is a top view diagram and perspective view diagram of the nozzle bumper.

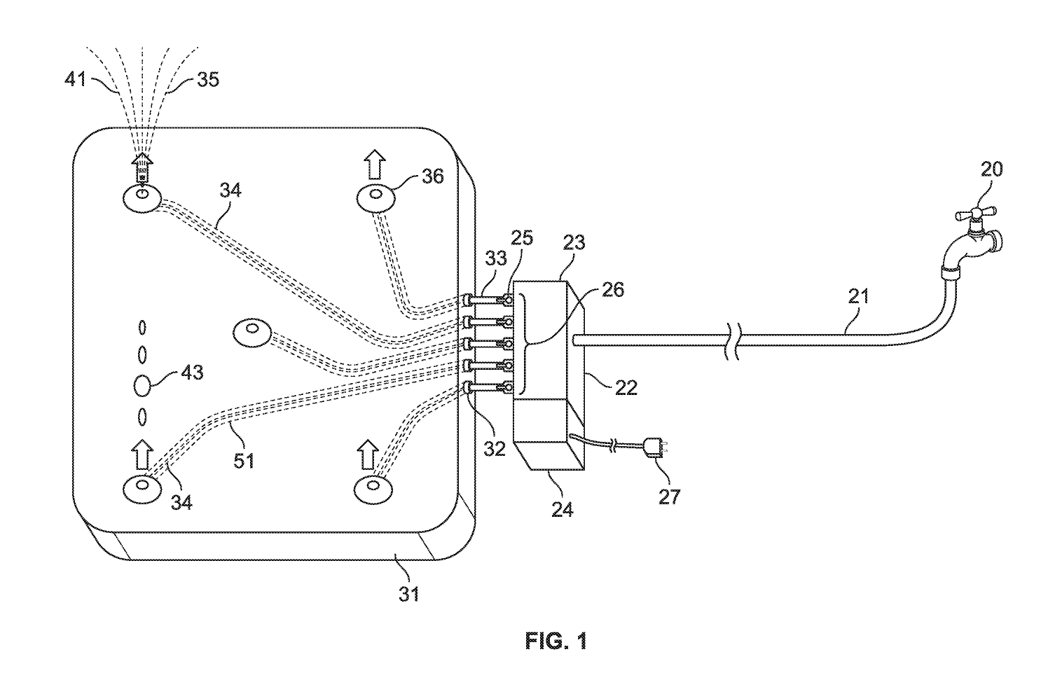

The following call out list of elements can be a useful guide in referencing the element of the drawings.
20 Spigot
21 Water Intake Line
22 Water Supply
23 Water Controller
24 Cpu
25 Valve
26 Valve Manifold
27 Water Controller Power Supply
28 Power Control Switch
31 Water Mat
32 Ports
33 Intake Tubing
34 Internal Tubing
35 Water Spray
36 Spray Nozzle
37 Manifold Outlet
38 Manifold Cover
39 Nozzle Bumper
40 Play Area
41 Misting Spray
42 High Spray
43 Big Water Droplet Spray
44 Droplet Spray
45 Peripheral Spray Line
46 Mat Layer
47 Misting Nozzle
48 High Spray Nozzle
49 Big Water Spray Nozzle
50 Water Layer
51 Conduits
52 Water Mat Edge
53 Water Bladder
54 Shallow Pool
55 Sprinkler Mat Upper Layer
56 Sprinkler Mat Lower Layer

### DETAILED DESCRIPTION OF THE PREFERRED EMBODIMENT

Glossary: a CPU is a central processing unit, which processes electronic data.

A water mat receives water from an intake water line 21 that is connected to a water supply 20. The intake water line 21 can be a garden hose for example. The water supply 20 can be a faucet such as a faucet connected to household water supply. The intake water line 21 is received at a water line connection 22 which can be formed as a garden hose connector. The water line connection 22 is formed on a water controller 23. The water controller 23 houses a valve manifold 26 that includes a number of valves 25. The water controller 23 also has a CPU 24. The CPU 24 is connected to a water control a power supply 27. The power supply 27 can be by household electric current or by battery. Instead of a CPU 24, the water controller 23 can be controlled using a simple circuit. The controller may have a CPU 24 that can be replaced with a microcontroller if necessary to conserve cost.

The water controller 23 selectively controls solenoid valves 25 that dispense water from a valve manifold 26. The valve 25 is connected to an intake tubing 33. The intake tubing 33 is connected to a port 32. The port 32 is formed on the water mat 31. A spray nozzle 36 is formed on an upper surface of the water mat 31. The water mat 31 has a thickness and can have a sidewall that has a number of ports 32 formed on the sidewalk. The ports 32 allow internal tubing 34 to travel between the valve 25 and the spray nozzle 36. The spring nozzle 36 is formed on an upper surface of the water mat.

A water spray 35 can be directed upward toward users. Additionally, a variety of buttons or sensors can be used for changing the mode of operation. For example, the water spray can be random, sequential or timed. The waterjet spray can also be configured to shoot up beads of water or a stream of water. The pad constitutes the upper surface of the mat and can be sized as a PVC pad of 10′×10′. The garden hose connector is preferably standard size for connection to a garden water spigot.

The water pressure at the spigot 20 is generally at approximately 80 pounds per square inch also known as 80 psi which is a common standard of pressure. The water intake line 21 also receives pressure at household water pressure. The household water pressure is transmitted through the intake water line to the water line connection 22. The water line connection 22 is also made to withstand the household water pressure. The water controller 23 reduces the household water pressure using the valves 25 which collectively make up the valve manifold 26. Since the CPU 24 controls the valve manifold 26, and is being supplied power by a water controller power supply 27, the CPU 24 can regulate the water temperature by controlling the activation or lack of activation of the valve manifold 26. The power control switch 28 allows the user to turn off the power to the device.

The intake tubing 33 provides water to the water mat 31. The household water pressure is the high-pressure side of the water system. Ports 32 on the water mat receive water at a lower pressure than household water pressure, generally less than 80 pounds per square inch, such as at 20 pounds per square inch of pressure. Thus, the low-pressure side is located from the valve 25 toward the water mat 31 and includes elements such as the intake tubing 33, and the ports 32. The ports 32 that connect to the water mat 31 provides low-pressure water to the water lines also called the conduits 51. The conduits 51 can be formed of tubing located between the upper layer of the water mat 31 and the lower layer of the water mat 31. The water mat 31 can be formed as a laminate construction where the conduits 51 can be laminated between the layers of the water mat 31.

The conduits 51 house the internal tubing 34. The internal tubing 34 is waterproof, but the conduits 51 can be not waterproof. The internal tubing connects between the intake tubing 33 and the spray nozzles 36. The valves 25 are connected to a manifold outlet 37 such that the valve manifold 26 has a plurality of manifold outlets 37. The manifold outlets 37 are individually controlled and on the low-pressure side of the device. The manifold has a manifold cover 38. The manifold cover 30 is preferably rounded and smooth on the external surface to provide a safe environment.

The spray nozzles 36 have a nozzle bumper 39. The nozzle bumper 39 can be made of foam, or a soft plastic. The nozzle bumper 39 preferably has a water bladder 53 formed as an elastomeric bladder that can squirt out water when stepped on. The spray nozzle 36 can be configured to feed the water bladder 53. The water bladder 53 is constantly pressurized by the spray nozzle 36 when the water controller 23 is sending enough water to the spray nozzle 36. The water bumper may have a tactile surface, such as a rubbery top surface to allow stepping. The water bumper is preferably laminated to the mat layer 46 and fixed to the mat layer 46. The water bladder three is below the nozzle bumper 39. The water bladder 53 may be integrally formed with the nozzle bumper 39 to provide a single thick rubber top such as a silicone top nozzle bumper 39 that squirts the greater amount of water when stepped on.

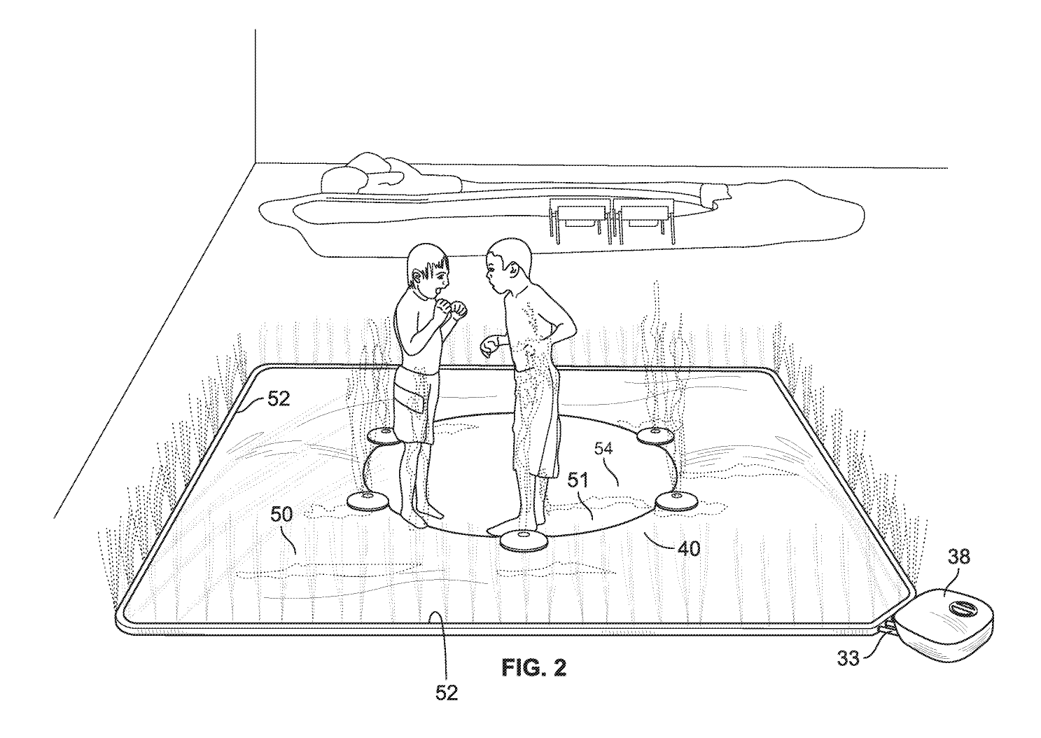

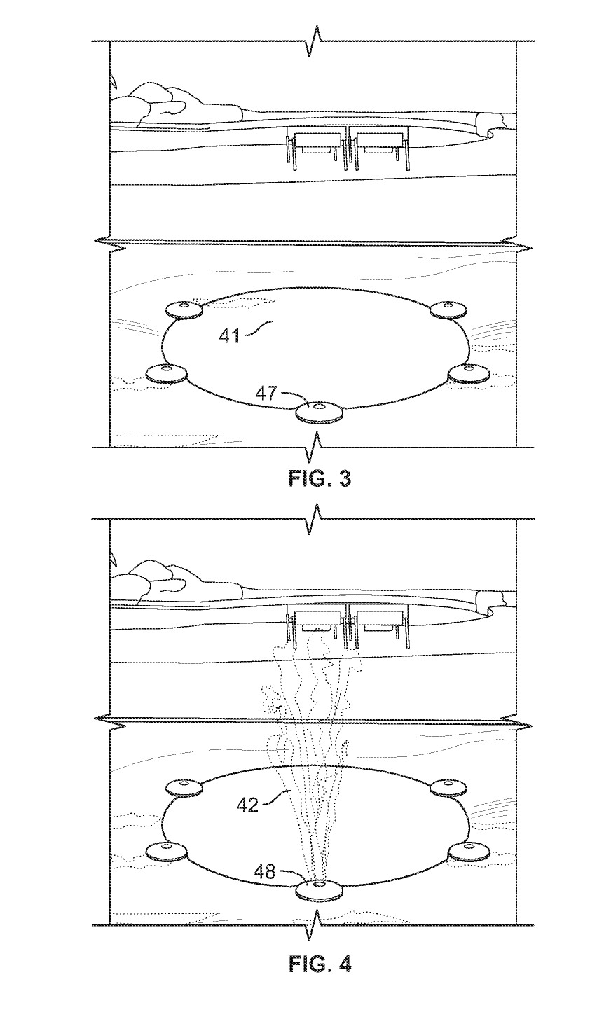

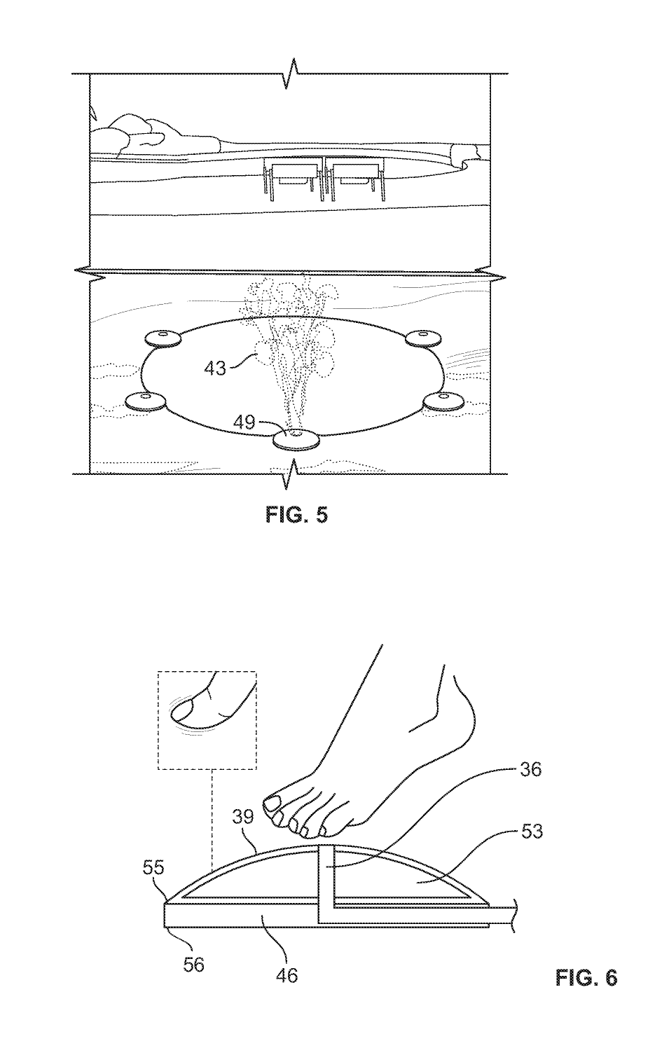

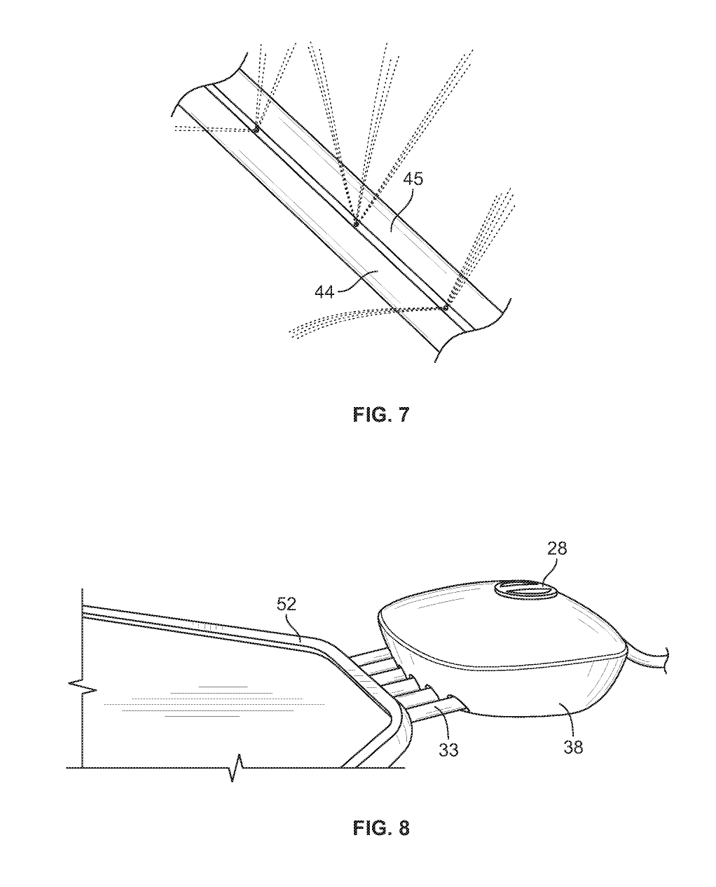

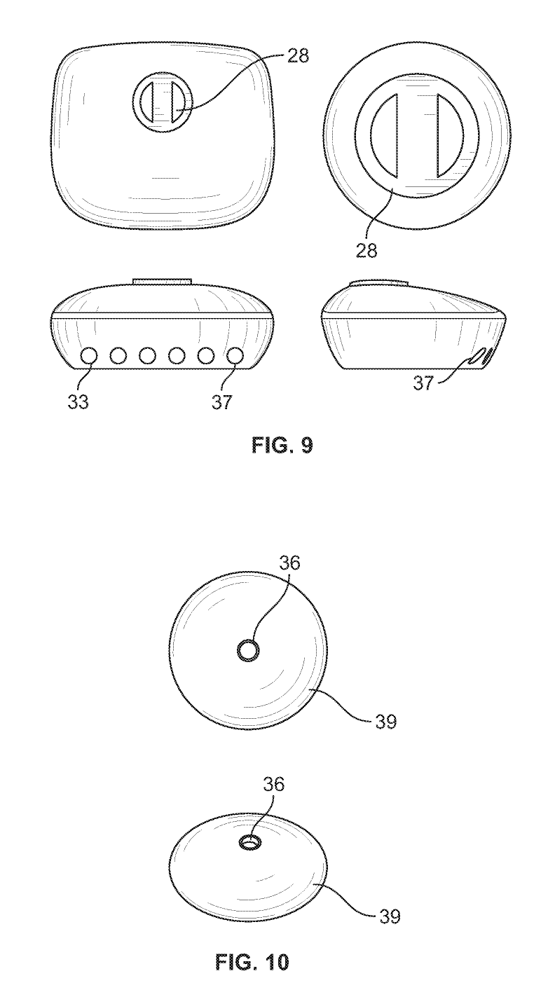

The water layer 50 can be provided that holds a layer of water so that children that jump on the mat can feel a soft watery layer. The water layer 50 even if only a few centimeters thick can significantly weigh down the water mat to provide a more stable grip between the water mat and the ground. The water layer 50 can be disposed as seen in FIG. 2 to surround a center area so that the center area can be formed as a shallow pool 54. The shallow pool 54 retains water from the sprays so that children can get more than one splash out of the same quantity of water. As the children stomp around on the shallow pool 54, the water splashes out, but is replenished by water being sprayed from the nozzles located at the top of the nozzle bumpers. Thus, the water layer 50 serves a first function of creating a wall barrier to retain a shallow pool 54. The water layer 50 also dampens the stepping by children so that it cushions shock. The water layer 50 is not pressurized and not in motion. It would be prefilled such as from the water controller 23. One of the intake tubing 33 can be configured to connect to the water layer 50 and provide a set amount of water that is drained later when the water mat is stowed away. One or more drain plugs can be provided for draining the water layer 50 after use such as when the user desires to roll up the water mat for storage.

The play area 40 generally contains a wide variety of different configurations of spray such as a misting spray 41, a high spray 42, a bit water droplet spray 43 and a regular droplet spray 44. Additionally, a peripheral spray line 45 can be pressurized from the water controller 23 and surround the area with a fine misting spray or a droplet spray 44. The water mat edge 52 can be defined by the peripheral spray line 45 and can be integral to the peripheral spray line 45. The variety of different sprays are provided by a variety of different nozzles including the misting nozzle 47, the high spray nozzle 48, and the big water spray nozzle 49.

The water controller 23 is the control unit and preferably attaches or detaches from the pad and has a battery or high-voltage electrical operating control. The CPU can open up random control switches to allow water to flow through. Preferably, the water controller 23 can be user programmed such as by a smart phone or by a preset program. The water controller 23 provides a way of user customizable water spray control.

The sprinkler mat has a pair of sprinkler mat layers including a sprinkler mat upper layer 55 and a sprinkler mat lower layer 56. The layers can be made of plastic sheeting and the plurality of intake tubing that continues on between the sprinkler mat layers as conduits. Therefore, the conduits are sandwiched between the sprinkler mat layers. The conduits can be loose between the sprinkler mat layers for the conduits can be adhered to the layers. The space between the sprinkler mat layers can be air evacuated so that sprinkler mat sticks to the conduits and does not allow the conduits to move freely. The conduits can be made of flexible tubing. The peripheral spray line can be along the sprinkler mat periphery which is the water mat edge 52. The peripheral spray line can also be sandwiched between the sprinkler mat upper layer 55 and the sprinkler mat lower layer 56.

The nozzle bumpers are mounted to the sprinkler mat upper layer 55. The nozzle bumpers can be made of a soft plastic or elastomer such as silicone. The nozzle bumpers can be circular in profile and should have a diameter at least three times the size of the nozzle.

1. A sprinkler mat apparatus comprising:
a. an intake water line configured to be connected to a water supply, wherein the intake water line connects to a water line connection;
b. a water controller, wherein the water line connection is formed on the water controller;
c. a plurality of valves, wherein each valve of the plurality of valves is independently controlled by the water controller, wherein the water controller has a random mode, wherein the plurality of valves is connected to a valve manifold;
d. a sprinkler mat formed as a sheet and having a thickness, wherein the sprinkler mat is connected to the water controller;
e. a plurality of intake tubing connecting each valve of the plurality of valves to a plurality of ports spray nozzle, wherein the intake tubing continues internally within the sprinkler mat as conduits; and
f. spray nozzles, wherein each of the spray nozzles is connected to a respective intake tubing.

2. The sprinkler mat apparatus of claim 1, wherein the sprinkler mat is made of a pair of sheets, wherein the conduits are configured between the pair of sheets.

3. The sprinkler mat apparatus of claim 1, wherein the water controller uses a CPU for processing controlling different modes of operation.

4. The sprinkler mat apparatus of claim 1, further including a water layer that is filled with water and forms a wall barrier to retain a shallow pool of open water.

5. The sprinkler mat apparatus of claim 1, further including a peripheral spray line having misting nozzles for emitting a fine spray, wherein the peripheral spray line is mounted along the periphery of the sprinkler mat.

6. The sprinkler mat apparatus of claim 1, further including nozzle bumpers, wherein the spray nozzles are mounted to the nozzle bumpers.

7. The sprinkler mat apparatus of claim 6, wherein the sprinkler mat is made of a pair of sheets, wherein the conduits are configured between the pair of sheets.

8. The sprinkler mat apparatus of claim 6, wherein the water controller uses a CPU for processing controlling different modes of operation.

9. The sprinkler mat apparatus of claim 6, further including a water layer that is filled with water and forms a wall barrier to retain a shallow pool of open water.

10. The sprinkler mat apparatus of claim 6, further including a peripheral spray line having misting nozzles for emitting a fine spray, wherein the peripheral spray line is mounted along the periphery of the sprinkler mat.
